(19) United States
(12) Patent Application Publication
(10) Pub. No.: US 2025/0137866 A1
(43) Pub. Date: May 1, 2025

(54) METHOD FOR DETERMINING LEAKAGES IN BUILDING ENVELOPES

(71) Applicant: Deutsches Zentrum Für Luft-und Raumfahrt e.V., Bonn (DE)

(72) Inventors: Benedikt KÖLSCH, Wuppertal (DE); Eckhard LÜPFERT, Köln (DE); Johannes PERNPEINTNER, Köln (DE)

(73) Assignee: Deutsches Zentrum Für Luft-und Raumfahrt e.V., Bonn (DE)

(21) Appl. No.: 18/836,075

(22) PCT Filed: Feb. 6, 2023
(86) PCT No.: PCT/EP2023/052803

§ 371 Date: Aug. 6, 2024

(30) Foreign Application Priority Data
Feb. 7, 2022 (DE) 10 2022 102 824.0

(51) Int. Cl. G01M 3/00

(52) U.S. Cl. CPC G01M 3/002

(57) ABSTRACT

A method for determining leakages in a building envelope of a building including the following steps: a) generating a positive or negative pressure in the building for a predetermined time duration within a predetermined period of time, wherein the predetermined time duration is shorter that the predetermined period of time, b) recording several image data of the building envelope by infrared thermography during the predetermined period of time, c) repeating steps a) and b), and d) evaluating the image data. The temperature changes caused by the repetition of step a) at leakages in the building envelope due to outflowing or inflowing air are detected.

The present invention relates to a method for determining leakages, in particular air leakages, in building envelopes.

Leakages in building envelopes lead to leaks in the associated building. The applicant is aware of various measurement methods for determining the airtightness of a building, wherein the measurement methods described do not necessarily represent a specific prior art.

In the so-called blower door test, a differential pressure is built up between the interiors of the building and the building's surroundings and the resulting volume flow is used as a measure of airtightness. Here, the entrance door or another opening of the housing is provided with a fan. The fan can be used to generate a static positive or negative pressure in the building. The air volume flow through the fan is measured. This makes it possible to quantify the integral airtightness of the building. Smoke detectors or air velocity meters can also be used to detect local air flows, which enables the location and size of a leak to be determined qualitatively.

Another method is the so-called tracer gas method. Here, a tracer gas that is easy to detect, often SF6, is introduced into the building to be examined and distributed. The decay curve of the tracer gas concentration in the room is determined by measuring the concentration within a certain time duration. This method is used to quantify the air exchange rate resulting from ventilation systems, open windows or uncontrolled leakages in the building, for example at material transitions and corners.

This method sometimes requires the tracer gas to be injected for several hours. Depending on the gas used, this can displace respiratory air and/or be harmful to the climate. Therefore, other use of the building is impaired during the measurement. Wind and other environmental conditions also influence the results of the measurement.

Infrared thermography can also be used to detect leakages in parts of the building. This visualizes local changes or deviations in surface temperatures as a result of flow through building components. However, the temperature difference between the inside of the building and the surroundings should be at least 5-10° C. in order to be able to resolve temperature differences. Here, it is difficult to tell the difference between a thermal bridge and an air leakage. Differential images can be used to improve the quality of the measurement. In this so-called differential thermography, an infrared image is first taken in the original state of the building and a second image is taken after a fan is switched on, which creates a positive or negative pressure in the building and thus a flow through the leakages. The time interval between switching on the fan and taking the image is usually several minutes to half an hour. This time is required to generate a sufficiently measurable local temperature difference. Both images are subtracted and the resulting thermographic image shows the temperature differences at the leakages, which can enable localization. As an extension of the differential measurement, the temperature trend of pixels or objects is sometimes analyzed after the fan is switched on. With such measurements, changes over the measurement period in wind, radiation temperature of the sky or surrounding object temperatures, which become visible as reflections in the image, can greatly distort the result, so that differential infrared thermography is usually only suitable for indoor use, i.e. for measuring individual rooms.

It is therefore an object of the present invention to provide a method and a system for determining leakages in building envelopes, in which a short measurement duration is realized and which is also advantageously suitable for outdoor areas and entire facades.

The method according to the invention is defined by claim 1.

In the method according to the invention for determining leakages in a building envelope of a building, the following steps are provided:
a) generating a positive or negative pressure in the building for a predetermined time duration within a predetermined period of time, wherein the predetermined time duration is shorter that the predetermined period of time,
b) recording several image data of the building envelope by means of infrared thermography during the predetermined period of time,
c) repeating steps a) and b),
d) evaluating the image data, wherein the temperature changes caused by the repetition of step a) at leakages in the building envelope due to outflowing or inflowing air are detected and determined, respectively.

Since the period of time and time duration are specified in step a), image data can be evaluated in an advantageous manner, as it is known when a temperature change caused by the positive or negative pressure in the building can occur on the building envelope. The image data can be assigned in terms of time via corresponding time stamps. This means that temperature changes induced by external influences, such as shadows or wind influences, can be easily detected and eliminated, respectively.

The image data is preferably recorded in the specified period of time, both during the duration in which the positive or negative pressure is generated and outside this time duration. Preferably, the image data is recorded from the outside, i.e. the outside of the building envelope is recorded.

Preferably, the predetermined periods of time are of equal length when repeating step a). It may also be provided that, when repeating step a), the predetermined time durations in which positive or negative pressure is generated in the building are of equal length, wherein the point in time within the predetermined periods of time at which the generation of positive or negative pressure in the building begins is the same. In other words: The temporal sequence for generating the positive or negative pressure in step a) is the same for each repetition of step a). This means that positive or negative pressure is generated periodically in the building, so that the image data can be evaluated in a particularly advantageous way, as the temperature change that also occurs periodically at the leakages due to the periodic generation of positive or negative pressure can be detected in a particularly advantageous manner.

The positive or negative pressure in the building can be generated by means of a blower door system (i.e. by means of a blower installed in a door opening). Such systems have been tried and tested many times and are therefore particularly suitable for the reproducible generation of positive or negative pressure in a building.

The method according to the invention has the particular advantage that it can be carried out relatively quickly compared to conventional methods and is relatively insensitive to environmental influences.

The method may provide that in step b) a temporal series of image data of the same location of the building envelope is recorded. In other words: While performing the method, the camera used to record the image data is not moved and the images are captured at the same time interval. Of course, it is also possible for image data to be recorded using a moving camera, wherein image data from the same location on the building envelope is assigned to one another for later evaluation using image recognition.

When evaluating the image data in step d), the temporal sequence of the temperature can be broken down into frequency components for each pixel of the image data and analyzed. This makes it possible to analyze the image data in a particularly advantageous manner.

When evaluated, the analysis can be carried out using an excitation frequency of the generation of positive or negative pressure in the building. The excitation frequency can advantageously be used to infer signals caused by the positive or negative pressure.

A Fourier transformation, preferably a fast Fourier transformation, can be carried out over each pixel of the image data to break down the temporal sequence of the temperature into frequency components.

In step a), a positive pressure with a target pressure of at least 50 Pa can be generated. Such a value has proven to be particularly advantageous.

Furthermore, it may be provided that in step a) the predetermined period of time has a duration of x seconds and the predetermined time duration has a duration of x/2 seconds. In this way, the positive or negative pressure can be generated periodically in an advantageous manner. For example, the period of time can be 20 seconds long and the time duration in which the negative or positive pressure is generated can be 10 seconds.

The image data can be recorded using an infrared camera. For example, the infrared camera can be a camera that is sensitive in the spectral range of 7-14 μm.

In principle, the method according to the invention can also be used to detect leakages on walls within a building, wherein in this case, in addition to a negative or positive pressure in a room in the building, a temperature difference must be created to an adjacent room from which image data is recorded. For example, the temperature difference can be generated by heating or cooling one of the two rooms.

In the following, the invention is described in more detail with reference to the following figures. In the figures:

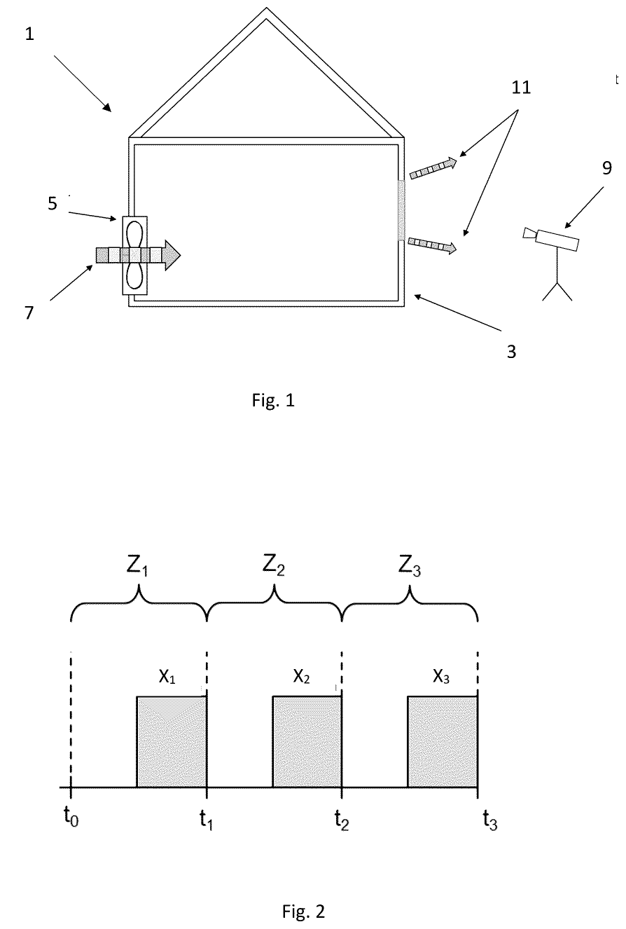

FIG. 1 shows a schematic illustration of a system for performing the method according to the invention,

FIG. 2 shows a schematic illustration of the temporal sequence of the periodic generation of a positive pressure, and

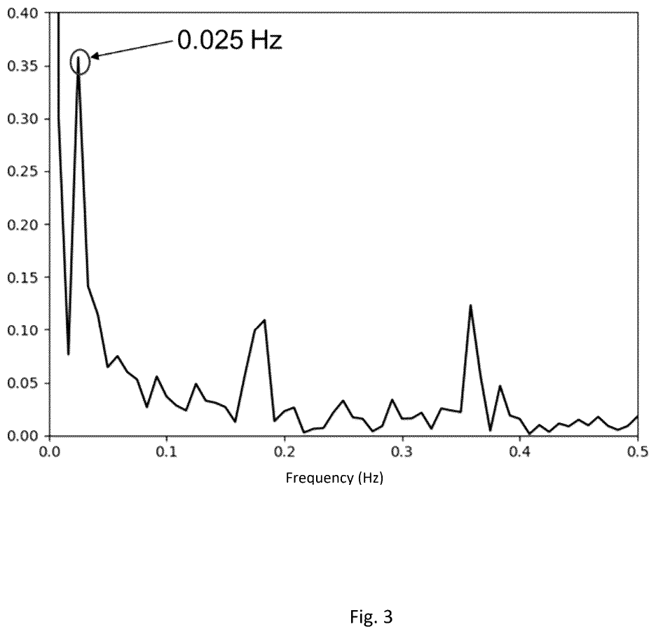

FIG. 3 shows the evaluation using fast Fourier transformation on an exemplary pixel at a leakage.

FIG. 1 schematically shows a system for determining leakages 11 in a building envelope 3 of a building 1. A blower door system 7 is installed in an opening 5 in building envelope 3, for example in a door, by means of which a positive pressure can be generated in building 1. An infrared camera 9 is installed on the outside of building 1, which records image data from building envelope 3. Due to the positive pressure in building 1, air escapes through leakages 11 in building envelope 3 and temperature changes occur, which are recorded by infrared camera 9.

In the method according to the invention for determining leakages 11 in building envelope 3 of building 1, the following steps are performed:
a) First, a positive or negative pressure is generated in building 1 for a predetermined time duration Xₙ within a predetermined period of time Zₙ, wherein the predetermined time duration Xₙ is shorter than the predetermined period of time Zₙ. During the predetermined period of time Zₙ, several image data of building envelope 3 are recorded in step b) using infrared camera 9. Steps a) and b) are repeated in a step c).

In step d), the image data is evaluated, wherein the temperature changes caused by the repetition of step a) at the leakages 11 in building envelope 3 due to the inflowing or outflowing air can be detected.

In the method according to the invention, it can thus be provided that a positive or negative pressure is periodically generated in building 1. The predetermined period of time Zₙ or predetermined periods of time Zₙ and the predetermined time duration Xₙ or the predetermined time durations Xₙ are shown as a diagram in FIG. 2. For example, a predetermined time duration Xₙ, in which positive or negative pressure is generated in building 1, can be half as long as a predetermined period of time Zₙ. As shown in FIG. 2, the predetermined period of time Zₙ lasts from a point in time tₙ₋₁ to tₙ in one cycle. At around half of the predetermined period of time Zₙ, blower door system 7 is switched on so that positive or negative pressure is generated in building 1 (start of Xₙ). The time duration Xₙ, during which blower door system 7 is switched on, ends at the end of the predetermined period of time Zₙ. The repetition of the periods of time Zₙ results in a periodic rise and fall of the pressure in building 1 and thus also a periodic temperature change at the leakages 11 in building envelope 3. These can be recognized in an advantageous manner during the evaluation of the image data. As can be seen from FIG. 2, the specified periods of time Zₙ in step a) are always of equal length, as are the time durations Xₙ at which the positive or negative pressure is generated in building 1.

For the evaluation, a Fourier transformation, in particular a Fourier transformation (FFT) over each pixel of the image (equation (1)), is calculated and thus the temporal sequence of the temperature is broken down into frequency components and analyzed. The result of the FFT is a complex pair of values from which the amplitude (equation (2)) and the phase (equation (3)) can be determined for discrete frequencies in the signal.

$${F}_{n} = Δ t {\sum }_{k = 0}^{N - 1} T ( k Δ t ) {e}^{- i 2 π nk / N} = {Re}_{n} + i {Im}_{n} \qquad ( 1 )$$

$${A}_{n} = \sqrt{{Re}_{n}^{2} + {Im}_{n}^{2}} \qquad ( 2 )$$

$${φ}_{n} = {tan}^{- 1} ( \frac{{Im}_{n}}{{Re}_{n}} ) \qquad ( 3 )$$

FIG. 3 shows an example of the amplitude spectrum for a pixel near one of the two leakages 9. Since the period duration and thus also the frequency (in this example 0.025 Hz) with which blower door system 7 has excited the temperature oscillations on building 1 are known, the amplitude and phase spectrum at this frequency and, if necessary, at the harmonics can be evaluated for each pixel.

In this way, it can be evaluated for each pixel whether there is a temperature change with the known frequency or its harmonics, so that it can be concluded whether the pixel represents a location of a leakage 11 in building envelope 3.

Thus, the method according to the invention enables fast and reliable detection of leakages 11 in building envelope 3, wherein measurements can be carried out from the outside in a simple manner. In doing so, external interference factors are eliminated in an advantageous manner so that a reliable result is achieved. The results of the method according to the invention can also be easily interpreted by laypersons and are therefore more objective compared to conventional methods for detecting leakages in buildings.

### LIST OF REFERENCE NUMERALS

1 building
3 building envelope
5 opening
7 blower door system
9 infrared camera
11 leakages

1-10. (canceled)

11. A method for determining leakages in a building envelope of a building comprising the following steps:
a) generating a positive or negative pressure in the building for a predetermined time duration within a predetermined period of time, wherein the predetermined time duration is shorter that the predetermined period of time;
b) recording several image data of the building envelope by infrared thermography during the predetermined period of time;
c) repeating steps a) and b); and
d) evaluating the image data, wherein the temperature changes caused by the repetition of step a) at leakages in the building envelope due to outflowing or inflowing air are detected.

12. The method according to claim 11, wherein the predetermined periods of time are of equal length when step a) is repeated.

13. The method according to claim 12, wherein when repeating step a), the predetermined time durations in which positive or negative pressure is generated in the building are of equal length, wherein the point in time within the predetermined periods of time at which the generation of positive or negative pressure in the building begins is the same.

14. The method according to claim 11, wherein the positive or negative pressure in the building is generated by a blower door system.

15. The method according to claim 11, wherein in step b) a temporal series of image data of the same location of the building envelope is recorded.

16. The method according to claim 11, wherein during the evaluation for each pixel of the image data the temporal sequence of the temperature is broken down into frequency components and analyzed.

17. The method according to claim 16, wherein in the evaluation the analysis is carried out using an excitation frequency of the generation of positive or negative pressure in the building.

18. The method according to claim 16, wherein a Fourier transformation, preferably a fast Fourier transformation, is carried out over each pixel of the image data to break down the temporal sequence of the temperature into frequency components.

19. The method according to claim 11, wherein in step a) a positive pressure with a target pressure of at least 50 Pa is generated.

20. The method according to claim 11, wherein in step a) the predetermined period of time has a duration of x seconds and the predetermined time duration has a duration of x/2 seconds.
